(19) United States
(12) Patent Application Publication
(10) Pub. No.: US 2026/0062331 A1
(43) Pub. Date: Mar. 5, 2026

(54) INTEGRATED MULTI-TROPHIC AQUACULTURE FILTER FOR RECIRCULATING AQUACULTURE SYSTEM

(71) Applicant: Mote Marine Laboratory, Inc., Sarasota, FL (US)

(72) Inventor: Adam Bell, Sarasota, FL (US)

(21) Appl. No.: 19/317,483

(22) Filed: Sep. 3, 2025

Related U.S. Application Data
(60) Provisional application No. 63/690,273, filed on Sep. 3, 2024.

(51) Int. Cl. C02F 3/32; C02F 3/30; C02F 103/20

(52) U.S. Cl. CPC C02F 3/325; C02F 3/303; C02F 2103/20

(57) ABSTRACT

An integrated biofilter for a re-circulating aquaculture system is provided. The biofilter may include a moving bed biofilm reactor (MBBR) with biomedia elements configured to support bacteria growth and nitrification of the wastewater and an MBBR output configured to output biomass generated by the bacteria. The biofilter may also comprise a periphyton biofilter configured to introduce oxygen into the wastewater, and a halophyte biofilter comprising a plurality of plants. The halophyte biofilter configured to capture nutrients in the wastewater to generate edible plant mass.

### CROSS-REFERENCE TO RELATED APPLICATIONS

This application claims the benefit of U.S. Provisional Application No. 63/690,273 filed on Sep. 3, 2024, the entire contents of which are hereby incorporated herein by reference.

### TECHNICAL FIELD

Example embodiments generally relate to water treatment technology, and in particular wastewater treatment technology in aquaculture systems.

### BACKGROUND

Several governmental agencies and fish farming industry associations have reported on the growing global demand for marine and freshwater fish sourced protein. The industry that has emerged to satisfy this need is called aquaculture, the farmed production of fish of many varieties. The initial aquaculture methods are based on growing fish in open waters with the fish contained via nets or ponds at a density (fish per cubic meter) that is several orders of magnitude greater than fish experience in the wild. The higher-than-natural density of fish produces a high-than-natural density of wastewater which creates environmental pollution problems and higher disease risk for the fish being farmed. While the rapid growth in the production of farmed fish products has been achieved with open water aquaculture, there has been a growing number of land-based indoor recirculating aquaculture systems (RAS) that have proven to be economically viable as well as reducing the environmental risks associated with open water aquaculture.

In a RAS, pumped water continuously flows in a closed circuit usually under roof or in environmentally controlled facilities. Indoor aquaculture production using RAS technology is more sustainable due to its environmental compatibility, and more controllable due to the technology implemented in an aquaculture facility. However, since a RAS is a closed circuit system, treatment of fish wastewater is necessary to in order to maintain a healthy environment for fish farming. As such, improvements in the area of wastewater treatment are needed to support RAS implementations.

### BRIEF SUMMARY OF SOME EXAMPLE EMBODIMENTS

According to some example embodiments, a land-based re-circulating aquaculture system is provided. The aquaculture system comprises a tank having a tank input and a tank output; a filter operably coupled between the tank output and the tank input; a pump operably coupled between the tank output and the tank input and configured to pump wastewater from the tank output through the filter to the tank input; and a solids removal unit operably coupled to the pump and configured to remove solids from the wastewater exiting the tank output. The filter, according to some example embodiments, may comprise a moving bed biofilm reactor (MBBR) comprising biomedia elements configured to support bacteria growth and nitrification of the wastewater, and an MBBR output configured to output biomass generated by the bacteria. The aquaculture system may also comprise a periphyton biofilter configured to introduce oxygen into the wastewater, and a halophyte biofilter configured to capture nutrients in the wastewater to generate edible plant mass.

According to some example embodiments, an integrated biofilter for a re-circulating aquaculture system is provided. The biofilter may comprise a moving bed biofilm reactor (MBBR) comprising biomedia elements configured to support bacteria growth and nitrification of the wastewater, and an MBBR output configured to output biomass generated by the bacteria. The biofilter may also comprise a periphyton biofilter configured to introduce oxygen into the wastewater, and a halophyte biofilter comprising a plurality of plants, the halophyte biofilter configured to capture nutrients in the wastewater to generate edible plant mass.

According to some example embodiments, an example method for operating a re-circulating aquaculture system is provided. The example method may comprise pumping wastewater from an aquaculture tank out of a tank output to an integrated biofilter; removing solids from the wastewater exiting the tank output; and passing the wastewater through the integrated biofilter to generate treated water. Moreover, passing the wastewater through the integrated biofilter comprises passing the wastewater through a moving bed biofilm reactor (MBBR) comprising biomedia elements configured to support bacteria growth and nitrification of the wastewater; passing the wastewater through a periphyton biofilter configured to introduce oxygen into the wastewater; and passing the wastewater through a halophyte biofilter comprising a plurality of plants. In this regard, the halophyte biofilter may be configured to capture nutrients in the wastewater to generate edible plant mass. The example method may also comprise returning the treated water to the tank via a tank input.

### BRIEF DESCRIPTION OF THE DRAWINGS

FIG. 1 illustrates a re-circulating aquaculture system according to some example embodiments;

FIG. 2 illustrates a periphyton biofilter according to some example embodiments;

FIG. 3 illustrates a halophyte biofilter according to some example embodiments;

FIG. 4 illustrates a moving bed biofilm reactor (MBBR) according to some example embodiments;

FIGS. 5A-5C illustrate example configurations of integrated biofilters according to some example embodiments;

FIG. 6 is a graph of measured pH values for an integrated biofilter experiment according to some example embodiments;

FIG. 7 is a graph of measured nitrification rates for an integrated biofilter experiment according to some example embodiments;

FIG. 8 is a graph of the relative abundance of algal populations for an integrated biofilter experiment according to some example embodiments; and

FIG. 9 is a flow chart of operating a re-circulating aquaculture system comprising an integrated biofilter according to some example embodiments.

The figures herein are for illustrative purposes only and are not necessarily drawn to scale.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As mentioned above, a challenge for recirculating aquaculture systems (RAS) must have some form of wastewater treatment in order to keep a clean and healthy environment for fish farming or other applications, such as, scientific testing and the like. Treating fish wastewater or aquaculture effluent in a RAS to remove waste gases, organisms, and chemicals can be expensive with respect to energy utilization and treating wastewater can also require special attention to maintain water quality control.

Many wastewater treatment approaches require electrical power, for example, for pumps and aeration systems that operate to separate and extract wastewater solids from the system. The use of electrical power for these purposes can reduce the financial viability of an RAS because such overhead costs cut into margins to a degree that can cause a land-based RAS to be non-viable for fish farming. As such, it would be beneficial to develop solutions that require less overhead costs and, more specifically, require less electrical power to perform wastewater removal. Accordingly, passive filtration approaches may be preferable, since such solutions may require less or no electrical power and other overhead costs to operate. As such, according to some example embodiments, biofiltration techniques may be useful since biofilters may rely on sustainable organic matter, such as plants and bacteria, to perform filtration.

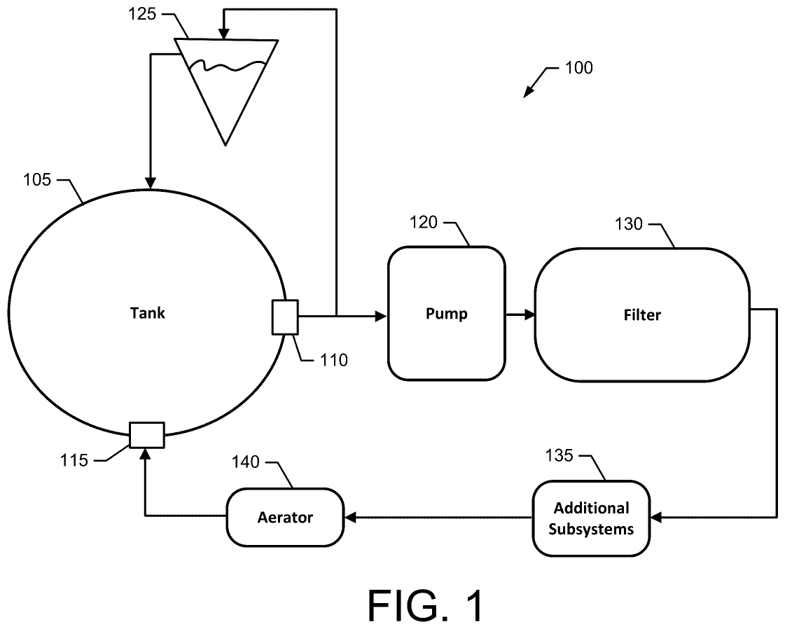

FIG. 1 illustrates an example recirculating aquaculture system (RAS) 100 configured to maintain optimal water quality and environmental conditions for aquatic organisms (e.g., fish, shellfish, etc.) through a closed-loop water treatment and circulation process, according to some example embodiments. The RAS 100 includes a tank 105 that houses the aquatic organisms and is equipped with a tank output 110 and a tank input 115 to facilitate continuous water flow from and to the tank 105. In this regard, wastewater exits the tank 105 through the tank output 110 due to being fluidly coupled to a pump 120, which propels the water through a series of components, including treatment components. Such components include a solids removal subsystem 125 (or solids removal unit), which is configured to extract suspended solids and particulate matter to reduce organic load. According to some example embodiments, the solid removal subsystem may comprise a settling tank that permits solids to settle to the bottom of the settling tank so that wastewater without such solids can be recirculated, for example, back into the tank 105.

The pump 120 may also propel the wastewater, in some cases, partially treated wastewater, through a filter 130. The filter 130 may further treat the wastewater, for example, by absorbing and removing finer particulates and substances through mechanical, biological, or chemical filtration. As further described below, the filter 130 may be an integrated biofilter that comprises a unique combination of biofilter components that, when operating in unison, extract a significant amounts of undesired particulate from the wastewater. In this regard, the integrated combination biofilter operates in a largely passive manner to, for example, a significant reduction in the use of electrical power and other overhead requirements to achieve desired treatment relative to conventional solutions. According to some example embodiments, the filter 130 may comprise plant-based filtration. For saltwater implementations, a halophyte-based filtration approach may be used. Additionally, according to some example embodiments, a periphyton-based filtration approach may also be used (e.g., in combination with the plant-based, halophyte filtration and other filtration approaches). In this regard, according to some example embodiments, a periphyton implementation may involve use of a complex mixture of algae, cyanobacteria, heterotrophic microbes, detritus, and the like that attaches to submerged surfaces to perform a filtration function. Also, according to some example embodiments, the filter 103 may include a moving bed biofilm reactor (MBBR). The MBBR may comprise carriers or biomedia elements that support the growth of a biofilm on the surfaces of the biomedia elements. The biomedia elements, which are reusable and remain in a tank of the MBBR, may be agitated via, for example, mixing or aeration, and biofilm on the biomedia elements may consume, absorb, extract, or the like organic pollutants and nutrients (e.g., nitrogen, phosphorous, etc.) in the wastewater. The MBBR may include or work in conjunction with a clarifier or filter that removes excess biomass (e.g., sloughed-off biofilm). According to some example embodiments, the combination of, for example, a halophyte biofilter, a periphyton biofilter, and an MBBR into a single integrated filtration system may be implemented. According to some example embodiments, the rather than separate tanks for each filtration component, the components may share a single filtration tank that operates as a combination halophyte-periphyton-MBBR biofilter.

Downstream of the filter 130, the treated wastewater may be routed through additional subsystems 135, which may include, for example, UV sterilizers, temperature control units, pH controllers and regulators, fine particle removal systems, disinfecting systems, CO₂ removal systems, or the like, depending on the specific requirements of the system. Before the treated water is returned to the tank via the tank input 115, the treated water may pass through an aerator 140, or the aerator 140 may be disposed within the tank 105. The aerator 105 may reintroduce oxygen in to the treated water to support aquatic life and further enhance biological filtration. According to some example embodiments, configurations of the system 100 may enable efficient water reuse, minimize waste, support a stable aquatic environment, and provide an output of an edible plant mass that may be used to feed the aquatic organisms within the tank 105.

As described above, various example embodiments of the filter 130 may comprise a plurality of biofilter components or reactors. Such biofilter reactors may assembled into various configurations with respect to type, order, and merging. Some example type of biofilter reactors include periphyton biofilters, plant-based biofilters such as halophyte biofilters, and biofilm carrier-type biofilters such as MBBRs. Such example types of biofilter reactors may be configured into an integrated biofilter for a RAS in a variety of ways, such as in different qualities and series or parallel configurations with respect to wastewater flow. Moreover, in some example embodiments, biofilter reactors may be merged together, for example, by sharing a tank or other interface to form a merged biofilter reactor.

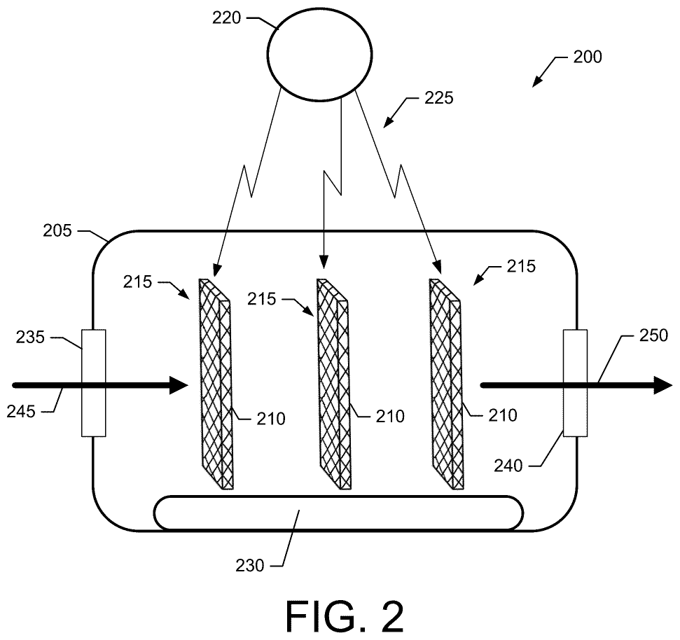

As an example of a component biofilter reactor reference is now made to FIG. 2, which illustrates an example periphyton biofilter 200. The periphyton biofilter 200 may comprise a tank 205 with a flow input 235 and a flow output 250, one or more periphyton substrates 210, a light source 220, and an agitator 230. In general, a flow 245 of wastewater passes through the flow input 235 of the tank 205, into the tank 205 with the periphyton substrates 210 with periphyton material 215 attached thereto, and exits the tank 205 via the flow output 240 as indicated by outbound flow 250.

The periphyton biofilter 200 may operate as a biological filtration system that uses periphyton 215 (e.g., an algal and bacterial biofilm) that attaches to the periphyton substrates 210 to remove nutrients and contaminants from wastewater that passes through the periphyton biofilter 200. A periphyton biofilter, according to some example embodiments, may use photosynthesis to reintroduce oxygen while consuming carbon dioxide to create a value-added product in the form of periphyton biomass, as further described below. The periphyton biofilter 200 shown in FIG. 2 is but one configuration of a periphyton biofilter and it is understood that other periphyton biofilter configurations may be used according some example embodiments. According to some example embodiments, the periphyton substrates 210 may take a number of different forms. For example, the periphyton substrates 210 may comprise a net, a mesh, a plate, or the like that is suspending within the tank 205. The material of the periphyton substrates 210 may comprise plastic, polyethylene, or another inert material that is suitable for attachment and growth of the periphyton 215. The type of substrate used for the periphyton substrates 210 may selected based on a desired periphyton density and nutrient uptake efficiency.

The periphyton 215, according to some example embodiments, may comprise a number of components including an algae, such as, diatoms, green algae, or the like. According to some example embodiments, the periphyton 215 may comprise algae, cyanobacteria, protozoa, fungi, other forms of bacteria, and detritus. Periphyton 215, according to some example embodiments, may be a type of microbial aggregate comprised of algae, bacteria, and other micro- and meso-organisms. Other names for periphyton include pond scum, biofilm, microphytobenthos, or aufwuchs. Aufwuchs are the plants and animals adhering to parts of rooted aquatic plants and other open surfaces, other organisms, and detritus coating rocks and plants in an aquatic environment often fed on by fish specialized as scrapers.

The periphyton 215 may form a biofilm on the periphyton substrates 210 and the biofilm may perform nutrient uptake to capture and remove nutrients and contaminants thereby operating as a biofilter. The algae of the periphyton 215 may photosynthesize to produce oxygen and organic material. Microbes of the periphyton 215 may perform nutrient cycling by breaking down organic material and recycle nutrients such as nitrogen and phosphorous. According to some example embodiments, the periphyton 215 not only perform a biofiltering role, but the periphyton 215 may also form a food source for aquatic organisms such as invertebrates and fish, which may be the invertebrates or fish within the tank 105 of the RAS 100.

As mentioned above, the periphyton 215 may be exposed to a flow rate of wastewater through the periphyton biofilter 200. As the wastewater flows through the periphyton biofilter 200, the nutrient-rich wastewater is continuously provided the periphyton-covered surfaces of the periphyton substrates 210. However, the flow rate used to pass wastewater through the periphyton biofilter 200 may be carefully controlled. In this regard, if the flow rate is too high, then contact time is reduced and the effect on nutrients and contaminants is reduced. However, if the flow rate is too low, then sedimentation can occur within the tank 205 causing a reduction in oxygen levels. According to some example embodiments, an agitator 230 may be included that aerates or mixes the contents of the tank 205 to minimize sedimentation even with slow flow rates.

Additionally, a light source 220 may be included to support the photosynthesis capabilities of the periphyton 215. In this regard, according to some example embodiments, the light source may be external or internal to the tank 205. In an external example embodiment, the tank 205 may include an opening or be sufficiently transparent to allow the periphyton 215 to be exposed to the light 225. While an artificial lighting system may be used as the light source 220, according to some example embodiments, the light source 220 may be the sun and the light 225 may be natural sunlight. By using sunlight, the electrical power requirements of the system may be relatively reduced.

As mentioned above, the nutrient uptake performed by the periphyton 215 may form a biomass. Such biomass may be harvested in a variety of ways, such as scraping or rinsing the periphyton substrates 210. However, in some example embodiments, the biomass may be harvested automatically via scrapers that are, for example, robotic scrapers operate to acquire the biomass, store the biomass, and may even distribute the biomass within the tank 105 as feed for the aquatic organisms in the tank 105.

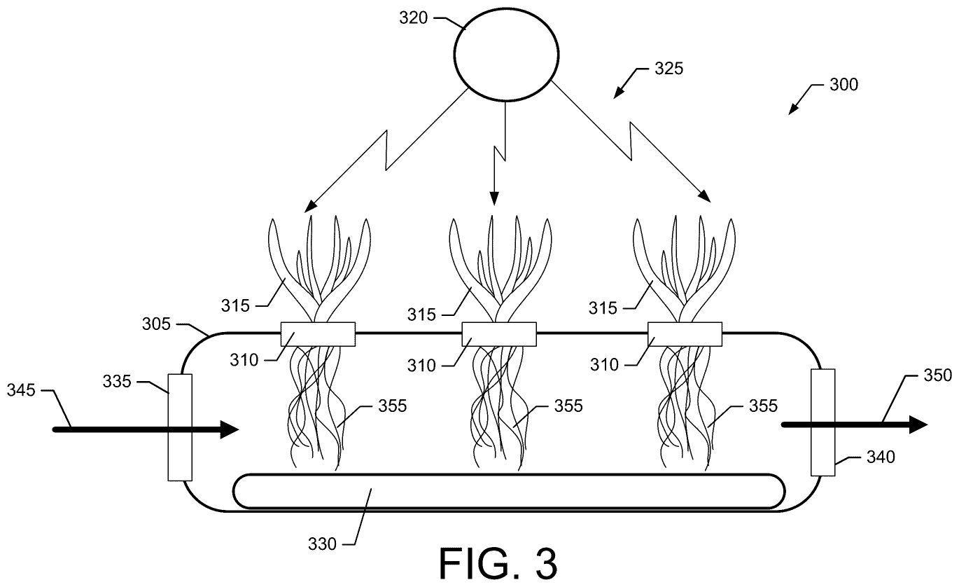

Now referring to FIG. 3, an example plant-based biofilter in the form of a halophyte biofilter 300 is shown. It is understood that while the examples provided herein refer to halophytes as an example plant for a plant-based biofilter, any type of plant that may thrive in an aquaculture wastewater environment may be used in place of or in combination with halophytes. The halophyte biofilter 300 may comprise a tank 305 with a flow input 335 and a flow output 350, one or more halophyte holders 310 with respective halophytes 315 having roots 355 therein, a light source 320, and an agitator 330. In general, a flow 345 of wastewater passes through the flow input 335 of the tank 305, into the tank 305 with the roots 355 of the halophytes 315, and exits the tank 305 via the flow output 340 as indicated by outbound flow 350.

The halophyte biofilter 300 may operate as a biological filtration system that plants such as halophytes 315 to remove nutrients and contaminants from wastewater that passes through the halophyte biofilter 300. The halophyte biofilter 300 shown in FIG. 3 is but one configuration of a halophyte biofilter 300 and it is understood that other halophyte biofilter configurations may be used according some example embodiments. According to some example embodiments, the halophyte holders 310 may be elements that can be secured to the halophytes 315 to hold the halophytes 315 in place within the tank 305 of the halophyte biofilter 300. In this regard, according to some example embodiments, the halophyte holders 310 may be mesh pots that permit the roots of the halophytes 315 to pass through the openings in the mesh and be disposed in the wastewater filled tank 305. The number of halophytes 315 that are included in the halophyte biofilter 300 may be varied based on the nutrient and contaminate content of the wastewater.

The halophytes 315, according to some example embodiments, may be plants that thrive in a saltwater or saline environment. In general, halophytes 315 have a particular propensity to thrive in high nutrient and contaminant environments that many other plant may find to be toxic. Halophytes 315 may absorb water and nutrients in high-slat conditions and may employ salt regulation mechanisms to do so. As such, halophytes 315 may operate to normalize salinity levels within the wastewater to maintain a desired salinity within, for example, the RAS 100. Examples of halophytes that may be used in example embodiments include, but are not limited to, Salicornia (glasswort), Spartina (cordgrass), Atriplex (saltbush), Mangroves (e.g., Rhzophora, Avicennia, and the like). According to some example embodiments, edible halophytes may be used, such as, Salicornia, that may be recycled as food for the aquatic organisms in, for example, the tank 105.

As mentioned above, the halophytes 315 may be exposed to a flow rate of wastewater through the halophyte biofilter 300. As the wastewater flows through the halophyte biofilter 300, the nutrient-rich wastewater is continuously provided the roots 355 of the halophytes 315 and the roots 355 are able to pull nutrients and contaminants from the wastewater for use in growth and photosynthesis processes. According to some example embodiments, a soil-type substrate (e.g., small pebbles) may be included within the tank 305 for the roots 355 to grow into and be secured. According to some example embodiments, an agitator 330 may also be included that aerates or mixes the contents of the tank 305 to minimize sedimentation.

Additionally, a light source 320 may be included to support the photosynthesis capabilities of the halophytes 315. The light source may be external to the tank 305 and the halophytes 315 may extend out of the tank 305 to interact with the light 325 from the light source 320. While an artificial lighting system may be used as the light source 320, according to some example embodiments, the light source 320 may be the sun and the light 325 may be natural sunlight. By using sunlight, the electrical power requirements of the system may be relatively reduced.

As mentioned above, the nutrient uptake and photosynthesis performed by the halophytes 315 may cause plant growth and such growth, or the plants in their entirety, may be regularly harvested. Such harvesting and subsequent replanting may be performed. In some example embodiments, the harvested halophytes 315 may be used as food for the aquatic organisms in, for example, the tank 105. The process of harvesting, replanting, storing, and distributing the halophytes 315 as food for the aquatic organisms may be performed, for example, in an automated manner a robotic harvester/planter. Additionally, feeding may be scheduled and automated using stored halophytes 315 that have been harvested.

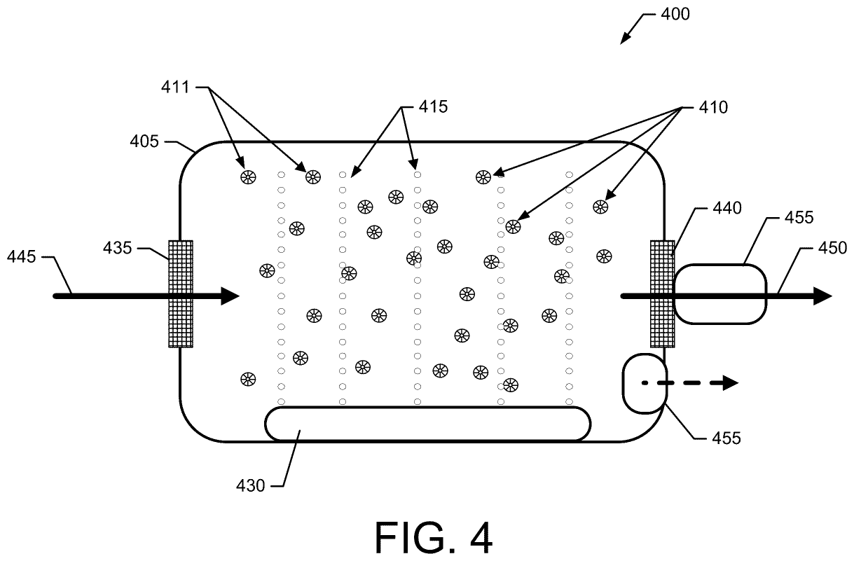

Now referring to FIG. 4, another example component biofilter reactor is illustrated in the form of an MBBR 400. The MBBR 400 may comprise a tank 405 with a flow input 435 and a flow output 450, a plurality of biomedia elements 410, and an agitator 430. In general, a flow 445 of wastewater passes through the flow input 435 of the tank 405, into the tank 405 with the biomedia elements 410 with biofilm 411 attached thereto, and exits the tank 405 via the flow output 440 as indicated by outbound flow 450. According to some example embodiments, the flow input 435 or the flow output 440, or both, may comprise a mesh or other size limiting passage ways to prevent the biomedia elements 410 from flowing out of the tank 405.

The MBBR 400 may operate as a biological filtration system that uses biofilm 411 grown on the high-surface area biomedia elements 410 for interaction with the wastewater passing through the MBBR 400. The biomedia elements 410 may be shaped in a variety of ways to increase surface area for layers of biofilm growth. According to some example embodiments, the biomedia elements 410 may have a hub and spokes configuration as shown in FIG. 4. The biomedia elements 410 may be formed of a plastic or other material that will operate as a substrate for the growth of biofilm 411. The biofilm 411 that grows on the biomedia elements 410 may remove nutrients and contaminants from wastewater that passes through the MBBR 400. In this regard, the biomedia elements 410 may be lightweight such that aeration 415 from the agitator 430 may cause sufficient turbulence in the tank 405 to cause the biomedia elements 410 to disperse across the volume of the tank 405. As such, the wastewater passing through the tank 405 will interact with the biomedia elements 410 and the biofilm 411 on the biomedia elements 410 will operate to capture and absorb nutrients and contaminants in the wastewater. The number and form factor of the biomedia elements 410 may be selected depending on the volume wastewater and nutrient and contaminant load of the wastewater. Moreover, the flow rate through the MBBR 400 may also be controlled for nutrient uptake efficiency. The MBBR 400 shown in FIG. 4 is but one configuration of an MBBR and it is understood that other MBBR configurations may be used according some example embodiments.

MBBRs, such as the MBBR 400, may be referred to as “biofilm slurry reactors.” Such MBBRs may combine the advantages of suspended and attached biofilm growth processes onto freely mobile suspended carriers (i.e., the biomedia elements 410) inside a tank 405 of the MBBR bioreactor. While the biofilm 411 of the MBBR 400 need not be a photosynthesizing material, the biofilm 411 may operate similar to the periphyton 215 in that the biofilm 411 not only perform a biofiltering role, but also forms a food source for aquatic organisms such as invertebrates and fish, which may be the invertebrates or fish within the tank 105 of the RAS 100. According to some example embodiments, the MBBR 400 may include a biomass removal system 455 that removes biomass that accumulates within the tank 405 for use, for example, as a food source. Such biomass may be harvested. In some example embodiments, the biomass may be harvested automatically and the biomass may be stored and distributed within the tank 105 as feed for the aquatic organisms in the tank 105. Additionally, the treated wastewater leaving the tank 405 may also pass through a clarifier 455 of the MBBR 400, which may operate to further remove particulate matter from the treated wastewater leaving the tank 405.

Having described some example embodiments of biofilter reactor components of an integrated biofilter, a description of combinations and merging of these bioreactor components will now be described in the form of, for example, aquaculture biofilter combinations (ABCs). According to some example embodiments, MBBRs, halophyte biofilters, and periphyton biofilters may be used to construct an ABC. The resulting integrated biofilter may operate to treat wastewater produced by the fish or other aquatic organisms growing in the tank 105 of an RAS 100. The ABC may produce water of good quality that can be recycled and reused within the RAC 100 and the tank 105 that holds the fish or other aquatic organisms. Accordingly, an ABC may integrate several different biological filtration processes that produce high quality recirculated water with less energy than conventional approaches. In addition, some example embodiments also recover nutrients that may be used in the form of food for the aquatic organisms that, for example, are being farmed or studied in the RAS 100. As such, example embodiments operate to improve the sustainability of RASs, such as the RAS 100. An ABC may be employed as an adenosine triphosphate (ATP) synthase binding cassette that helps to save energy through savings on carbon dioxide scrubbing and aeration system costs for the reintroduction of oxygen.

According to some example embodiments, an integrated multi-tropic aquaculture (IMTA) biofilter is described that is configured to perform water quality treatment for a recirculating aquaculture system (RAS) by integrating an MBBR operating as a nitrification biofilter, a periphyton biofilter that reintroduces oxygen into the treated water and cycles nitrogen, and a halophyte biofilter that repurposes nutrients as edible plant mass. Such a biofilter, according to some example embodiments, may also consume carbon dioxide and less energy than these components when operating independently. The solution, according to some example embodiments, also creates a valuable biomass that can be used as food source.

Some example embodiments combine an MBBR, such as MBBR 400, with a periphyton biofilter, such as periphyton biofilter 200, to, for example, maximize the benefits of ecological and chemical leverage points found in these approaches when considered in nature. An MBBR, such as the MBBR 400, may provide secondary wastewater treatment of ammonia and biological oxygen demand, while producing nitrate and carbon dioxide. However, a periphyton biofilter, such as the periphyton biofilter 200 may provide denitrification, photosynthesis, and tertiary treatment. Such photosynthesis may result in carbon dioxide uptake and oxygen production, according to some example embodiments. Periphyton produced by the RAS can also be repurposed as a feed for fish, for fertilizer, or as another value-added product.

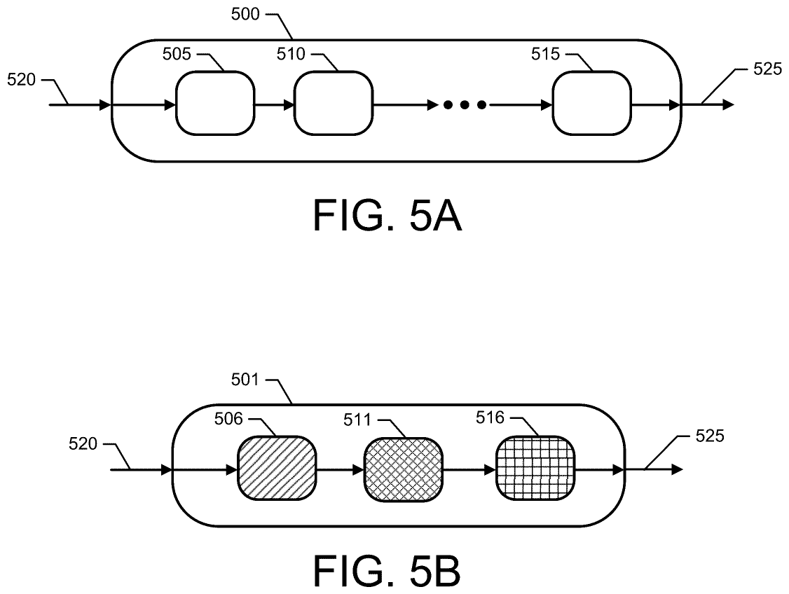

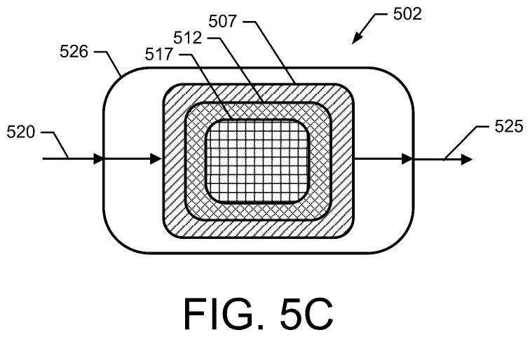

Now referring to FIGS. 5A to 5C, various configurations of combined and integrated biofilters for use in aquaculture systems are described. In this regard, FIG. 5A illustrates an example integrated biofilter 500 that has a series of biofilter reactors. The integrated biofilter 500 shows that any number of biofilter reactors, such as biofilter reactors 505, 510, and 515, may be combined into an integrated biofilter to generate an aggregate water treatment effect in a re-circulating aquaculture system. In this regard, wastewater from the aquaculture system flows into the integrated biofilter 500 via flow 520 and the treated water exits the integrated biofilter 500 via flow via flow 525. The biofilter reactors 505, 510, 515, etc. may be any number and type of biofilter reactors, such as, for example, a periphyton biofilter, a halophyte biofilter, an MBBR, or the like. The combination of the biofilter reactors may result in improvements and control of water quality that exceeds the results of independent use of such biofilter reactors with the use of less power to support such water quality.

FIG. 5B illustrates a more specific example of an integrated biofilter, as integrated biofilter 501. Again, the integrated biofilter 501 has a series of biofilter reactors. However, the input flow 520 of wastewater first interacts with an MBBR 506, then periphyton biofilter 511, and then halophyte biofilter 516, leading to an output flow 525 of treated water. The integrated biofilter 501 shows that specific biofilter reactors may be combined into an integrated biofilter to generate an aggregate water treatment effect in a re-circulating aquaculture system. While the MBBR 506, the periphyton biofilter 511, and the halophyte biofilter 516 may operate as described herein, the combination of these biofilter reactors may result in improvements and control of water quality that exceeds the results of independent use of such biofilter reactors with the use of less power to support such water quality.

FIG. 5C illustrates another example of an integrated biofilter, as integrated biofilter 502. In the integrated biofilter 502, the component biofilter reactors are integrated such that, for example, the component biofilter reactors share some elements such as a tank. As such, the same tank may be used for the MBBR 507, the periphyton biofilter 512, and the halophyte biofilter 517. In this configuration, additional synergies with respect to operation and overhead reduction can be realized (e.g., smaller overall size, less power requirements, etc.) The integrated biofilter 502 shows that specific biofilter reactors may be combined in various ways into an integrated biofilter to generate an aggregate water treatment effect in a re-circulating aquaculture system. While the MBBR 507, the periphyton biofilter 512, and the halophyte biofilter 517 may operate as described herein (e.g., using the same tank), the combination of these biofilter reactors may result in improvements and control of water quality that exceeds the results of independent use of such biofilter reactors with the use of less power to support such water quality.

Having described various configurations of integrated biofilters, a description of biofilter reactors and some testing of interaction between such biofilter reactors will now be described. For example, combinations MBBRs with periphyton biofilters and halophyte biofilter will be described. Such integrated multi-trophic aquaculture (IMTA) implementations forms an ecological pairing of a fed species, such as fin fish, with an extractive species such as Ulva, where the extractive species growth may be supplemented from the waste of the fed species. Aquaculture systems such as these have the potential for addressing United Nations sustainability goals for food security and economic growth, while reducing malnutrition. IMTAs can help to address the challenges of RAS implementations by increasing resource recovery, energy savings, and microbial diversity. Various combinations of species may be employed, including abalone, brine shrimp, oysters, clams, mullet, sea bass, sea bream, halophytes, and macro/microalgae. Another example of IMTA benefits is that, for example, cultured Litopenaeus vannamei (whiteleg shrimp) in an IMTA with periphyton nets can experience a higher survival rate (93%), more efficient food conversion rate (Food Conversion Rate of 1.02), and significantly lower effluent nitrogen concentration (12% lower), relative to monoculture implementations. Thus, IMTAs integrated into RAS, where the conventional RAS biofilter is supplemented or replaced with an IMTA biofilter that produces an value-added species can be implemented successfully.

As described above, the use of periphyton can involve a complex aquatic community of macro- and micro-algae, bacteria, and fauna that grows on a submerged substrate or substratum and is influenced by light and nutrients. Algal-bacterial consortiums treating mariculture wastewater can have a high nutrient removal capacity, while also providing a harvestable product, such as Chlorella or Scenedesmus. Harvested microalgae may be used as a source of Ω-3 fatty acids for aquafeeds or as β-glucans. Further, periphyton can be used for the cycling of nitrogen and photosynthetic production of dissolved oxygen (DO), and can be harvested and used as a replacement for commercial fish feeds. Moreover, a RAS that incorporates algal turf scrubbers may therefore be used to produce periphyton by repurposing waste nutrients into carbohydrates and Ω-3 fatty acids.

As described above and otherwise herein, ABCs may implement an approach that uses different combinations of biofilters within a RAS. See Table 1. The combinations have the

TABLE 1
Strengths and Weaknesses of Different Biofilters

| Type of | | |
|---|---|---|
| Biofilter | Strengths | Challenges |
| Periphyton | DO production, diverse | Operator skill, sunlight, |
| | bacterial/algae, resource | land, labor |
| | recovery, denitrification | |
| MBBR | Conventional, efficient | High energy, cost, low |
| | | nutrient use efficiency |
| Halophyte | Resource recovery, nitrate | Nutrient antagonism, labor |
| | uptake, off-flavor removal | |

potential to optimize aquacultured species production and resource recovery because each type of biofilter reactor has different strengths and challenges. For example, an MBBR paired with a periphyton biofilter can provide a high rate of ammonia oxidation while producing periphyton that can be harvested as a feed source. Therefore, periphyton ABCs may have complementary effects with other biofilter types, thus helping to address the challenges of RAS while reducing operating costs and overhead.

As mentioned above, MBBRs are a type of biofilter that can be used in a RAS implementation. MBBRs have high nitrification rates, and low complexity. Unfortunately, MBBRs can have high energy requirements to maintain biomedia elements in suspension and maintain dissolved oxygen (DO) demands of aerobic bacteria. In addition, MBBRs can lack conditions that favor denitrification, and electricity use for aeration and mixing in MBBRs can result in high operational costs and indirectly lead to greenhouse gas emissions. The efficiency of an MBBR can also decrease due to changes in temperature. Raising the nitrogen use efficiency may be particularly helpful for resource recovery in RAS.

Halophyte plants used in a halophyte biofilter reactor may be an excellent type of biofilter element because the plants can improve water quality and reclaim nutrients as a product. Sesuvium portulacastrum (sea purslane) and Batis maritima (saltwort) can maintain NH4+ and NO2− concentrations well below levels that are toxic to fish. Some phosphorus can potentially also be recovered through plant mass from a halophyte biofilter, although phosphorus uptake can rely on a number of water chemistry factors including pH, salinity, and phosphorus concentration. Assimilation of NO3− or a mix of nitrogen species can lead to markedly higher growth of Salicornia neei and Apium graveolens. However, such plants may also be inhibited by high NH4+ concentrations. Off-flavor compound producing microbes such as 2-MIB and geosmin may also be removed by biofilter plants. Plants with roots exposed directly to the water can be susceptible to nutrient antagonism, which occurs because ions of similar charge and size can interfere with the plant root adsorption process. An ABC that involves both periphyton and halophytes may generate a diverse microbiome that is complementary to halophyte growth.

Thus, according to some example embodiments, ABCs that that employ MBBRs, periphyton, and halophytes may interact to improve water quality, nutrient recycling, biological growth rates, and diversify the microbial community. For instance, the addition of a halophyte's root zone may help equilibrate pH and cycle nutrients. Adequate nitrification/denitrification and upregulation of amoA and nxrB may be realized, for example, in a lettuce RAS with humic acid as the electron donor. Via a pairing with Ulva, periphyton can receive a NO3− rich influent, which can be removed at a rate of up to 1.8 grams NOx-N/meter squared/day.

Differences in the microbial community may also affect the repurposing of periphyton and plants as feedstock or food. A higher abundance of diatoms may result in the halophyte/periphyton combination at certain times of the year due to climate at that time. In a lettuce/tilapia/periphyton implementation, the periphyton may differ significantly from the bacterial community in fish excrement, with periphyton, for example, being composed of Proteobacteria, Bacteroidetes, Actinobacteria, and Acidobacteria (pH 5.61 to 7.24). Periphyton may be paired to anaerobic digestion to produce CH4 in a system treating eutrophic waters.

Thus, a clear understanding of the strengths and disadvantages of different ABCs can be determined via implementation in accordance with various example embodiments. Periphyton biofilters can provide water treatment, resource recovery, and ecological diversity. Further, periphyton may be combined with MBBRs and halophytes to gain further advantages as indicated by response variables such as water treatment, recovery of nutrients by periphyton and halophytes, energy savings, and microbiome development. As such, ABCs, according to some example embodiments, may operate to influence water quality, resource recovery, and energy conservation in marine IMTAs, while optimizing food production.

In one example implementation, two pilot scale IMTA RASs were implemented where each RAS was a 2500 liter RAS. ABC experiments were to be performed in both RAS simultaneously in Spring and Summer trials. See Table 2.

TABLE 2
Summary of Experimental Order

| Aquaculture Biofilter | | |
|---|---|---|
| Combination (ABC) | Abbreviation | Trial |
| MBBR + Periphyton | M + P i | Spring |
| Halophytes + Periphyton | H + P i | Spring |
| Periphyton Only | P² i | Spring |
| MBBR + Periphyton | M + P i | Summer |
| Halophytes + Periphyton | H + P ii | Summer |
| Periphyton Only | P² ii | Sommer |

The approach was to use repetitions in both space and time. Three different biofilter combinations were studied: periphyton only (P²), periphyton plus halophytes (P+H), and periphyton plus a MBBR (P+M), where M=MBBR, P=Periphyton, P²=Periphyton Only, and H=Halophytes.

The design of the experiment involved the operation of two IMTA RAS with periphyton biofilters. Two zero discharge RAS were constructed with a volume of 2,500±10 liters (L). A 0.12 kiloWatt (kW) pump was placed in each cylindrical culture tank of the RASs, where the culture tanks has dimensions of 156 centimeters (cm) in diameter and 43 cm in height, with an operational volume of 924 L. The flow was set at to 12.1±1.0 L/meter. Water flow out of the culture tank was routed between a clarifier, a biofilter treatment train, and a recirculation line. Each clarifier had an influent and effluent port at the top and a solids tap on the bottom. The clarifier was operated at an overflow rate of 1.8±0.1 meters squared/hour or a volume of 75.7 L. The biofilter treatment train included four tanks in series. Each tank had a height of 54.0±1.0 cm, a length of 104.0±0.5 cm, a width of 66.5±0.5 cm and a working volume 375 L. Aeration was provided to the culture tank using a 132 Watt (W) blower.

For the P² implementation, the periphyton substratum was provided in the form of six high-density polyethylene nets suspended within each biofilter tank. Each suspended net had a thickness of 1 millimeter (mm), with elliptical holes (major holes=4.09 mm by minor holes=3.47 mm) and a surface area of 0.588 meters squared per net for a total biofilter net surface area of 14.1 meters squared (m²). The harvest regime for the periphyton tanks was determined based on operating conditions and periphyton growth. To keep fresh periphyton biomass growing on the nets, the tanks were sequentially harvested, cycling to the same tank after four weeks. Harvesting was carried out by pressure washing the nets through a sieve into a settling container. The fluid in the container was allowed to settle for 1 hour, then decanted, and the solids removed with a 100 micron net. Significant growth of periphyton biomass was realized.

For the M+P implementation, the MBBRs were designed to remove 1 milligram/L of Total Ammonia Nitrogen (TAN) in the influent. Biomedia elements were selected as the biofilm carrier (500 m²/m³) at 40% fill (by working volume) of the reactor tank. A 0.12 kW pump was placed into reactor tank to mix the water and maintain the biomedia elements/carriers in suspension. With three periphyton biofilter tanks, the harvest regime was adjusted to harvest 3 nets per week to keep approximately one quarter of the periphyton nets in the exponential growth phase.

For the H+P implementation, the halophyte system converted reactor A and B to halophyte biofilters. To do this, expanded polystyrene foam rafts containing 32 holes (diameter=5 cm) was placed in each reactor (46 plants/m2). Sesuvium portulacastrum (sea purslane) was planted by placing 128 small clippings (average 11.1±3.0 grams/plant) into perlite and potting soil (1:20 ratio) in a small planting pot (diameter=5 cm, height=4.5 cm). The pots were then suspended in the biofilter tank by placing them in the holes in the rafts. The plants were then acclimated for a 1-week period. Two periphyton biofilter tanks were run in the H+P implementation. The harvest regime was adjusted to harvest 4 nets per week to keep approximately one quarter of the periphyton nets in the exponential growth phase. The halophytes were permitted to grow freely through the experiment and harvested at the end of each trial.

The initial water was taken from a deep well and salt was added to achieve an initial salinity of 15 parts per trillion (ppt). Each RAS was stocked with Sciaenops ocellatus (red drum) at a stocking density of 14±0.5 kg/m³. Stocking density was maintained between 14 to 18 kg/m³ and within 1 kg of the replicate RAS. Fish were fed 180 grams/day of a feed that was 50% protein and 18% lipids by hand four times per day.

The analytical program is summarized in Table 3.

TABLE 3
Response Variables and Frequency of Measurements

| | Daily | Weekly | Monthly* |
|---|---|---|---|
| Water | DO, pH, temp, | TAN, NO₂⁻, NO₃⁻ | BOD₅ |
| Quality | salinity, PAR | alkalinity, PO₄^{3-†} | |
| Fish | Feed amount | | FCR |
| Periphyton | | DW, AFDW | TN, protein, lipids, |
| | | | microbiome |
| Halophyte | | | SGR, TN, root |
| | | | microbiome |
| MBBR | | | Microbiome |

*Monthly refers to a four-week cycle, the time period for every trial
^{†}Water quality parameters were measure twice per week except for PO₄³⁻ which was measured biweekly
‡Dissolved oxygen (DO), photosynthetically active radiation (PAR), total ammonia nitrogen (TAN), 5-day biochemical oxygen demand (BODs), feed conversion ratio (FCR), dry weight (DW), ash-free dry weight (AFDW), total nitrogen (TN), specific growth rate (SGR)

At least once per week at 13:00, a 50 mL water sample was collected from each RAS at three locations: the fish culture tank, the effluent to the first treatment system (the first reactor effluent for P² and H+P, the second reactor for M+P) and the effluent to the second treatment system (the third reactor for all). Salinity, pH, temperature, and DO were measured at least ten times per trial at the same location as the water samples. Analysis of NO3−, NO2−, and NH4+ was carried out on each of the water samples in duplicate using a spectrophotometer. Determination of NO3− was performed by ultraviolet absorption at a wavelength of 220 nanometers. Determination of NO2− was performed by the sulfanilamide method at a wavelength 540 nm. The salicylate method with absorption at a wavelength of 640 nm was used to measure NH4+. The ascorbic acid method was utilized biweekly to determine PO43-(EPA 365.3). Removal rates were calculated by taking the difference between the influent and effluent concentration. This difference was then divided by the hydraulic residence time of the biofilter tanks used for each specific treatment. Alkalinity was also measured, as well as the five-day biochemical oxygen demand (BOD5). The CO₂ concentration of each RAS was measured at least once per week using a CO₂ analyzer. Photosynthesis to respiration ratio (P:R) is a variable used to indicate the ecological dynamic between algae and heterotrophs, and this was also calculated. Photosynthetically active radiation (PAR) and temperature were datalogged. Underwater light was also measured by gently placing the sensor in the center of the tank and lowering it to the target depth.

Periphyton biomass was also measured. Eight sample strips made from the plastic periphyton netting (surface area=0.018±0.001 m²) were placed in the biofilter tank at the beginning of each trial. Each week, two strips were removed, and pressure washed through a sieve into a bag. The sample was then transferred to a graduated cylinder, allowed to settle for two hours, then decanted through a 35 μm mesh. Sample pans were allowed to dry for 24 hours at 105° C., then weighed to obtain the total dry weight (DW) per surface area of sample strip. Pans containing the dried sample were then combusted at 550° C. for 1 hour to find the ash free dry weight (AFDW).

Plant mass from halophyte growth was also measured. The initial weights (w₁) for sea purslane were measured during planting. The final weights (w₂) were taken destructively by weighing ten randomly selected plants per RAS at the end of each trial. The relative growth rate (RGR) was then calculated as the growth metric (Equation 1).

$$R G R = \frac{ln ( {w}_{2} ) \to ln ( {w}_{1} )}{{t}_{2} - {t}_{1}} \qquad [ E 1 ]$$

Fish grading was performed at the end of each trial. The tanks were drained, and the fish were removed from the culture tank. Fish were placed in a bucket with a low concentration of tricaine methanesulfonate until the fish became sedated enough to handle. The fish were then graded by length and mass. Fish were revived in an aerated holding container by gently moving to push DO past the gills. After grading, the fish were returned to the culture tank.

With respect to feed biomass and nutrient analysis, the total nitrogen content of feeds and solids were obtained using a total nitrogen analyzer. The protein content of periphyton was measured using the bicinchoninic acid (BCA) method. Alternatively, periphyton samples were sent out for protein analysis. The calculation for feed replacement uses the content of protein, the growth rate of periphyton. This was compared to the protein content and feed rate. Lipid extraction was also performed. The method utilized the chloroform/methanol solvent-extraction with modifications using a centrifuge to remove organic debris and treatment with 0.2 N KCl. Transesterification to fatty acid methyl esters (FAME) was performed by adding methanolic H2SO4 (20/1; v/v) at 80° C. for 60 min. Samples were then redried and suspended in 1 mL of n-hexane for analysis using a gas chromatography system equipped with a flame ionization detector (GC-FID). Chromatographic separation was performed by using a high-polarity DB-FFAP column. Analysis of FAME on the GC-FID was performed. The injection volume was 1 μL per sample into the inlet, which was set at 280° C. with a split ratio of 50/1. The carrier into the inlet was helium at a flow of 1.1 mL/min. The oven program was set to start at 80° C. for 0.5 minute with a ramp to 170 at of 35° C., a hold for 1 minute and then a ramp to 240° C. at 5° C./min, with a final hold of 12 minutes. The eluent from the column was measured destructively by the FID, which used hydrogen and air for fuel. The chromatogram was recorded and processed to gain the Kovat's retention index, retention time, and area under the curve.

With respect to microbiome methods, microbiome samples were collected from the periphyton biofilters, MBBRs, and the roots of sea purslane. DNA extraction was performed. Periphyton samples were taken with autoclaved tools from 3 spots, 3 cm down from the top of a periphyton net at the end of each trial. Halophyte samples were taken by clipping roots with sterile scissors and transferring them into bead beater tubes. MBBR samples were taken by rigorously shaking the biomedia suspended in 100 mL of sterile brackish water. The liquid was then filtered through 0.2-micron polycarbonate filter paper, which was then placed into bead beater tubes. The samples were verified for DNA concentration to ensure the exclusion of proteins and chaotropic salts from the DNA samples.

Culture independent methods, such as next generation sequencing, were performed. Polymerase chain reaction and next generation sequencing was also performed. The 16s primers used to target prokaryotes were 515F and 806R. The distributions and test assumptions for each test were checked, and differences between trial repetitions between RAS1/RAS2 and spring/summer sets were investigated. Repetitions were pooled together if no significant difference was found, or the difference is discussed in results. Paired t-tests were used when comparing trials of the same type.

For the generation rates, the overall difference was found by taking the difference between sample points divided by the hydraulic residence time (HRT). If no differences were detected, 83 comparisons were made primarily by single factor ANOVA. Unpaired t-tests were applied for critical p values <0.05 unless otherwise specified. The Kruskal-Wallis signed rank test was applied when the normality assumption was not met. Linear regression was applied as needed. Bioinformatics followed the MRDNA pipeline. In brief, the forward and reverse *.fastq files were processed for quality control. This included quality control measures, such as removal of short sequences (<150 bp), to generate operational taxonomic units (OTU) at a high level of sequence similarity (>97%) with chimeric sequences removed. OTUs were classified by comparison using the curated databases. Triplicates were organized by replicate and type. This resulted in spring and summer abundance tables at the species level. The alpha, beta, and gamma measure of diversity were calculated. The classification of OTUs was then sorted to the species level when possible and compiled into stacked bar charts for the OTU based analysis of the alpha and beta diversity. Data were then compared.

With respect to water quality analysis, averages and standard deviations for DO concentrations and pH for each trial are shown in Table 4.

TABLE 4
Trial DO Concentration and pH (n ≥ 10 for Each Trial)

| | Dissolved Oxygen | |
|---|---|---|
| Trial | (mg/L)^{a} | pH |
| M + P spring | 6.04 ± 1.08 | 6.71 ± 0.35 |
| M + P summer | 5.35 ± 1.36 | 7.86 ± 0.32 |
| H + P spring | 6.33 ± 1.33 | 7.35 ± 0.37 |
| H + P summer | 4.95 ± 1.10 | 7.55 ± 0.28 |
| P² spring | 5.67 ± 1.18 | 7.85 ± 0.11 |
| P² summer | 5.20 ± 0.91 | 7.55 ± 0.33 |

^{a}Average DO for summer sets was significantly greater than the spring average

There was no significant difference between RAS1 and RAS2 DO concentrations (p>0.10). However, a significant difference was identified between all trials for the spring and summer DO sets for H+P and M+P (p<0.001, n>20 per ABC). Summer DO levels were significantly lower than the spring set (p<0.01). This is likely because the increase in temperature lowers the saturation concentration of DO in water. There was also a seasonal difference for the pH levels, although the pH was more predominately influenced by the ABC. The only trials that showed a stable average pH above 7 were the P² spring and summer trials. This is likely due to the stabilizing ability of periphyton to consume aqueous CO₂ through photosynthesis and to produce alkalinity through denitrification.

A decline in pH over time was observed in the M+P and H+P trials. Alkalinity addition was necessary to maintain a stable pH. See Table 4.5.

TABLE 5
Alkalinity and Addition (n ≥ 8 per Trial)

| | Average Alkalinity | Alkalinity Added |
|---|---|---|
| Trial | (CaCO₃ mg/L) | (CaCO₃ g/day) |
| M + P i | 38 ± 5 | 17.85 ± 0.05 |
| H + P i | 101 ± 5 | 17.85 ± 0.05 |
| P² i | 115 ± 5 | 0 |
| M + P ii | 137 ± S | 8.93 ± 0.05 |
| H + P ii | 68 ± 5 | 8.93 ± 0.05 |
| P² ii | 96 ± 5 | 0 |

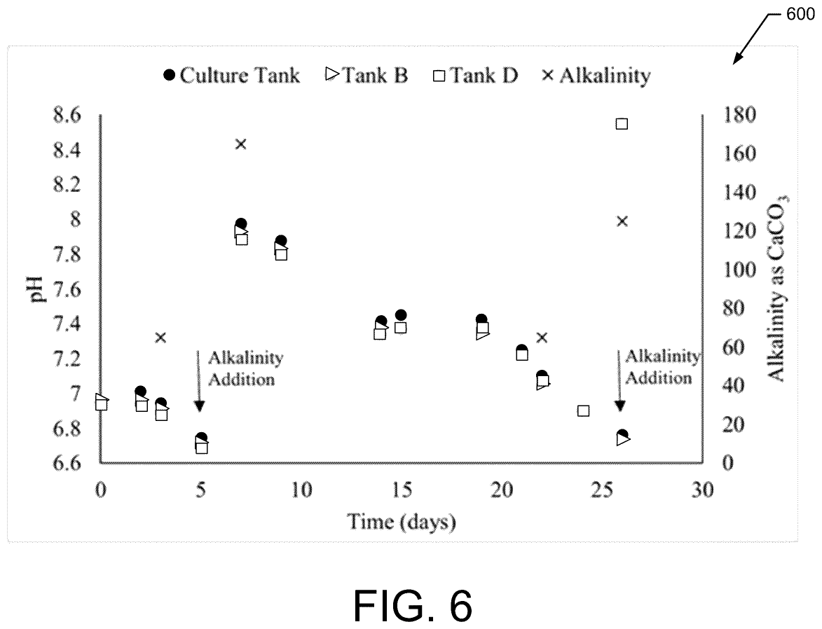

The drop in pH through time was correlated with a drop in alkalinity in the M+P and H+P trials (correlation coefficient=0.903). The evidence indicates that nitrification was occurring in the M+P and H+P trials. Alkalinity was added back into the system through denitrification. Due to the drop in pH, shown in graph 600 of FIG. 6, the addition of alkalinity was necessary to maintain conditions favorable for nitrification.

The DO and pH did not vary significantly between trials, however, the treatment system type (periphyton, MBBR, or halophyte) did show a difference. At the level of the treatment system, there were significant differences between trends. Comparisons between the pooled treatments revealed that periphyton generates alkalinity and DO while the MBBR and halophytes consume DO and alkalinity. See Table 6. It is more likely that alkalinity was added back into the system by the denitrifiers in periphyton.

TABLE 6
Generation Rates (n ≥ 20 for Each Treatment Parameter)

| | DO (mg/(L*d)) | pH |
|---|---|---|
| Average P* | +3.95 ± 6.52 | +0.0913 ± 0.350 |
| Average M | −5.39 ± 5.38 | −0.479 ± 0.310 |
| Average H | −4.65 ± 3.22 | −0.535 ± 0.337 |

*P for Periphyton, M for Moving Bed Biofilm Reactor, H for Halophytes

The concentration of total ammonia nitrogen (TAN) did not vary by RAS and was consistently removed by the different ABCs. See Table 7.

TABLE 7
Concentration for Total Ammonia Nitrogen
(TAN-N mg/L, n ≥ 8 per Trial)

| Trial | Fish tank | Treatment 1* | Treatment 2 |
|---|---|---|---|
| M + P spring | 0.61 ± 0.25 | 0.36 ± 0.29 | 0.26 ± 0.21 |
| M + P summer | 0.39 ± 0.12 | 0.21 ± 0.15 | 0.11 ± 0.075 |
| H + P spring | 0.86 ± 0.53 | 0.61 ± 0.48 | 0.46 ± 0.46 |
| H + P summer | 0.45 ± 0.11 | 0.22 ± 0.090 | 0.17 ± 0.072 |
| P² spring | 0.53 ± 0.45 | 0.41 ± 0.45 | 0.31 ± 0.34 |
| P² summer | 0.10 ± 0.01 | 0.06 ± 0.02 | 0.04 ± 0.02 |

*The first treatment concentration is the effluent from the first letter in the ABC and the second treatment is the second letter. For instance, for M + P the first treatment is the MBBR, and the second treatment is the periphyton biofilter.

The general trend was that the concentration from the fish tank was greater than the concentration from the first treatment which was greater than the concentration from the second treatment. The TAN concentration did vary between spring and summer sets (p<0.05). The concentrations of TAN were higher in the spring set than in the summer set. The variance was also higher. This is almost definitely due to seasonal effects. The effect could also be due to the higher availability of sunlight leading to higher TAN uptake by algae.

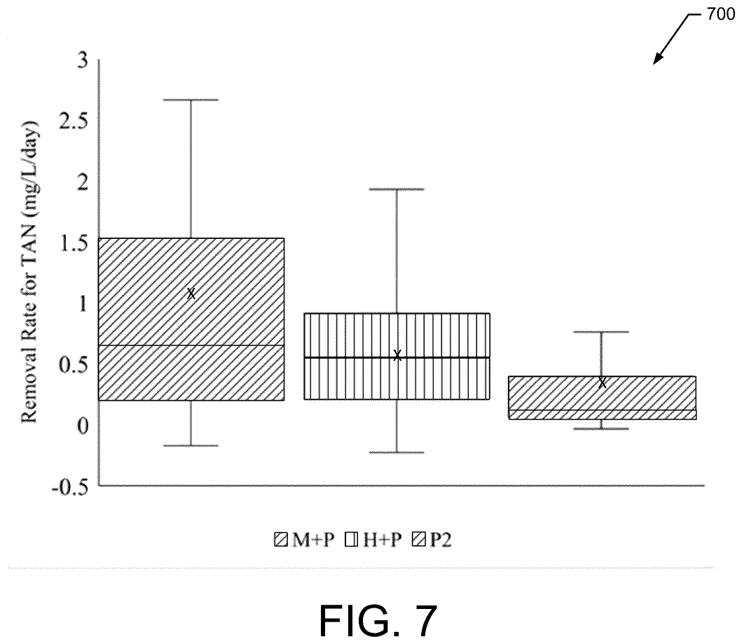

Nitrification rates in the biofilters were highest for the MBBR, followed by the halophytes, and then the periphyton, as shown in the graph 700 of FIG. 7. The M+P trial had the highest nitrification rate out of all trials (p<0.01), and the H+P trial had the second highest nitrification rate (p<0.03). The MBBR tank alone had the highest removal rate at 1.75=1.08 TAN-N mg/L/day which was significantly higher (p<0.010) in comparison to the other treatments. The nitrification rates for the spring set were higher than the nitrification rates for the summer set (p=0.03). Assuming Monod kinetics, this was because the spring influent contained a higher TAN concentration.

Nitrite and nitrate stayed at non-toxic concentrations throughout the trial. See Table 8.

TABLE 8
Nitrite and Nitrate Average Concentrations

| | M + P i | M + P ii | H + P i | H + P ii | P² i | P² ii |
|---|---|---|---|---|---|---|
| Nitrite (mg/L | 0.58 ± 1.13 | 0.17 ± 0.11 | 0.12 ± 0.63 | 0.19 ± 0.15 | 0.37 ± 2.16 | 0.01 ± 0.01 |
| NO₂\hat{ } as N) | | | | | | |
| Nitrate (mg/L | 99.9 ± 20.8 | 126.1 ± 22.1 | 134.4 ± 20.8 | 81.4 ± 15.2 | 104.2 ± 27.5 | 103.5 ± 14.1 |
| NO₃\hat{ } as N) | | | | | | |

The removal rates for nitrite across the biofilters were positive (average of 0.323±0.444 NO2-N mg/(L*d)) except for the MBBR in the M+Pii. The cause of this may be due to incomplete nitrification from the MBBR. There was no statistical difference between the trial types (p>0.05). The MBBR had the greatest magnitude of nitrate generation (2.86±7.43 NO3-N mg/(L*d)) although halophytes also had nitrate generation (0.698±14.2 NO3-N mg/(L*d)). Periphyton tanks generally removed nitrate (0.297±7.35 NO3-N mg/(L*d)) with the high variance being likely due to changes in microbial composition between experiments or seasonal effects.

No significant trends were detected in the remaining water quality parameters. The oxygen uptake rate was based on the BOD5 and found to be 0.81 mg/L/hr (n=4 per ABC). The CO₂ removal varied between 0.25 to 3.5 mg/L for each treatment type. The PO43− stayed in the range of 3.0±2.0 PO43-P mg/L and had only very slight removal in the treatment process.

This experiment took place at a subtropical location (27° 20′14″ North, 82° 32′7″ West). Temperature, light, and weather conditions contributed to the operational effects of the biofilter tanks. See Table 9.

TABLE 9
Seasonal Effects

| | Temperature | Sunlight |
|---|---|---|
| Trial | (° C.) | (MegaPAR/day/m²)* |
| M + P i | 24.28 ± 2.01 | 4.89 ± 0.60 |
| H + P i | 22.97 ± 3.55 | 6.06 ± 1.25 |
| P² i | 25.65 ± 1.29 | 7.39 ± 1.38 |
| M + P ii | 27.44 ± 1.60 | 7.71 ± 1.24 |
| H + P ii | 29.42 ± 1.04 | 7.49 ± 1.50 |
| P² ii | 29.45 ± 1.42 | 7.54 ± 1.30 |

*Calculated as ∫(PAR)∂t over one day,

The temperature dropped to a minimum during the mid-March H+Pi trial during a cold snap and was maximum in mid-July H+Pii trial in a heat wave. The average daily sunlight increased until the summer solstice in mid-June and then decreased. The heat wave likely increased the nitrification rate, although the temperature effect on the MBBR's nitrification rate is less than the expected effect. Nutrient removal is effective in high-rate algal ponds (HRAPs), where nutrients are repurposed into useful algae such as Tetraselmis and Phaeodactylum. HRAPs have a few setbacks including potential collapse due CO₂ limitation following exponential growth and pressure on filter feeders in IMTA systems.

Periphyton dry weights are shown in Table 10 and growth rates are shown in Table 11.

TABLE 10
Periphyton Dry Weight (grams/m²)

| | M + P | H + P | P² | M + P | H + P | P² |
|---|---|---|---|---|---|---|
| Time | Spring | Spring | Spring | Summer | Summer | Summer |
| Week 1 | 0.94 ± 0.50 | 1.06 ± 0.17 | 2.50 ± 0.39 | 6.00 ± 4.44 | 2.56 ± 0.11 | 1.33 ± 0.44 |
| Week 2 | 1.61 ± 0.33 | 2.11 ± 1.94 | 4.67 ± 1.22 | 7.83 ± 0.39 | 3.22 ± 2.56 | 3.44 ± 0.33 |
| Week 3 | 4.33 ± 0.39 | 3.06 ± 2.83 | 9.33 ± 4.56 | 16.67 ± 10.06 | 7.44 ± 0.11 | 10.11 ± 2.78 |
| Week 4 | 6.83 ± 1.11 | 4.39 ± 0.50 | 16.44 ± 9.33 | 21.89 ± 6.72 | 9.22 ± 1.33 | 11.50 ± 2.50 |

TABLE 11
Periphyton Growth Rates (grams/m²/week)

| | M + P | H + P | P² | M + P | H + P | P² |
|---|---|---|---|---|---|---|
| Time | Spring | Spring | Spring | Summer | Summer | Summer |
| Week 1-0 | 0.94 ± 0.50 | 1.06 ± 0.17 | 2.50 ± 0.39 | 6.00 ± 4.44 | 2.56 ± 0.11 | 1.33 ± 0.44 |
| Week 2-1 | 0.66 ± 0.33 | 1.06 ± 1.94 | 2.17 ± 1.22 | 1.83 ± 0.39 | 0.67 ± 2.56 | 2.11 ± 0.33 |
| Week 3-2 | 2.72 ± 0.39 | 0.94 ± 2.83 | 4.67 ± 4.56 | 8.83 ± 10.06 | 4.22 ± 0.11 | 6.67 ± 2.78 |
| Week 4-3 | 2.50 ± 1.11 | 1.33 ± 0.50 | 7.11 ± 9.33 | 5.22 ± 6.72 | 1.78 ± 1.33 | 1.39 ± 2.50 |

There was a growth rate change between trials carried out in the Spring versus the Summer. Overall, the summer set had higher periphyton DWs than the spring set. The growth rates were generally higher using synthetic wastewater, although somewhat less than the trial using hardhead catfish. The changes in periphyton biomass are likely due to operational variables such as stocking density, exposure to light, and substratum.

The red drum fish were initially found by grading to be 643±123 grams/fish (n=30). The red drum fish grew at a rate of approximately 0.17 kg/day. When stocked, the red drum started out as juveniles and reached adulthood approximately at approximately the end of the spring set. Average growth rate was 220±130 grams/fish/trial. The growth rates decreased chronologically with fish age. Initially the FCR was low (1.1) and increased through the range of the experiment to 2.0 at the end. The average fish size at the end of the experiment was 2370±379 g (n=16) with no statistically significant difference between RAS cohorts. The decrease in growth rate is likely due to the progression into adulthood. The feed rate through the trials remained the same and so the red drum devoted more energy to reproduction than to growth.

Before planting the size of halophytes were 11.1±2.99 grams per plant (n=128). By the end of the halophytes were 55.73±14.39 grams per plant. There was no difference between either the growth rates found in the replicates from the same trial or between the Spring and Summer sets. See Table 12.

TABLE 12
Halophyte Growth Rates (grams/day)

| | RAS1.H + | RAS2.H + | RAS1.H + | RAS2.H + |
|---|---|---|---|---|
| | Pi | Pi | Pii | Pii |
| Average | 0.9994 | 1.0871 | 1.0357 | 1.0502 |
| SD | 0.2327 | 0.2777 | 0.1563 | 0.3361 |

The SGR of the sea purslane was found to be 3.7±1.1%. The nitrogen content of the halophytes was found to be 1.83±0.90%, or about 0.11 grams of nitrogen/day. The growth rates are relatively high.

The mean concentration of lipid extract of periphyton from the Bligh and Dyer method was not found to be statistically different between trials. The concentration by percent of 88 dry weight was 4.55±2.24%. Overall, C16 was found to comprise the highest percentage of the total FAME. EPA were detected in almost all of the samples and DHA was detected in some. The variation in Ω-3 fatty acids indicates that the microalgae community in periphyton may vary from sample to sample. It could also indicate changes in the microbial community due to environmental variables such as weather or sunlight.

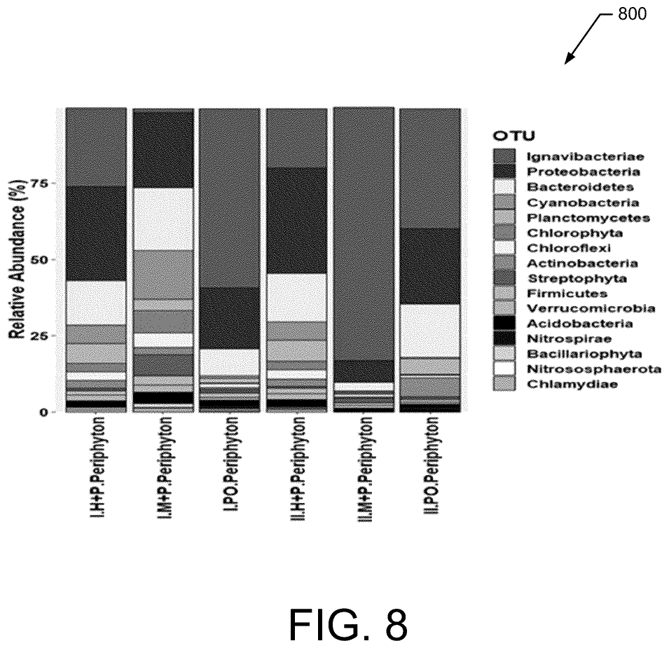

The results for the Spring prokaryote microbiome study are shown in graph 800 of FIG. 8. To broadly classify the microbial community by order, the community contained Ignavibacteriae, Proteobacteria, Bacteriodetes, and Cyanobacteria. The algae included Firmicutes, Bacillariophyta, and Cyanobacteria. The Chlorella genus was detected as one of the economically beneficial algaes. The nitrogen cyclers included Nitrospirae and Nitrosospharota. The top individual species of high abundance were Ignavibacterium album (60.5-83.8 in the MBBR samples), Haliea mediterranea (0.3-10.6% across all samples), Navicula lanceolata (4.8-6.3% in both P²). Lyngbya was also detected as filamentous algae. The highest AOB in abundance was Nitrospira marina (0.1-1.2%).

Using a data processing method, the alpha diversity for all spring trials was 375±40. The Summer prokaryote set showed a shift to a higher diversity with some predominate thermophilic species. The predominate species were Planktothricocoides raciborskii (filamentous algae, 1.1-20.6% in periphyton samples), Thermonema rossienum (0-5.4 in all), Lewinella nigricans (1.1-5.2% in all), Lewinella cohaerens (aerobic chemoorganotrophs, 0.4-4.8% in all).

The AOB were in a higher abundance with Candidatus Nitrospira salsa (0.4-4.2 in all) and the ammonia oxidizing archaea Candidatus Nitrosoarchaeum limnia (0.2-1.0%). Overall, the alpha diversity was higher than the spring trials at 500±40. The beta diversity for both spring and summer groups showed that 3 out of 4 of the MBBR groupings were isolated from the other 89 samples, indicating a consistent difference between the MBBR prokaryotes and periphyton prokaryotes.

The strengths of the P² trials were that the treatment maintained a stable pH without the addition of alkalinity and that it produced DO, while maintaining the nitrogen species within nontoxic limits. In comparison to RAS with a similar periphyton only configuration, the average DO production found in this experiment was less. This is likely due to the increased stocking density (e.g., stocking density of only 5 kg/m3 as compared to stocking density 14-18 kg/m3). The strengths of the M+P combination was that it nitrified at a high rate, was able to make up some of the DO lost by the MBBR treatment and did not require the use of a denitrifying unit.

Out of the different treatment systems, the MBBR was the greatest consumer of DO and required alkalinity addition. The MBBR also consumed the highest amount of energy (124 W or twice the energy of the P²). The partial removal of CO₂ by periphyton in the M+P combination indicated that the MBBR and periphyton can have a symbiotic role in treatment; albeit the correct balance to completely exhaust the CO₂ from the MBBR effluent is not known. The strengths of the H+P combination were that the plants experienced a high growth, and that the nutrient recovery was higher. The sea purslane had a high growth rate. This may have been due to oxygenation of the water by periphyton photosynthesis or due to plant growth promoting microbes.

This experiment was carried out to elucidate possible ways to improve RAS in the key areas of water quality, microbiome, efficiency, and resource recovery. Different aquaculture biofilter combinations (ABCs) were tested. The different ABCs were periphyton only (P²), MBBR+periphyton (M+P), and halophyte+periphyton (H+P). Each ABC was tested in duplicate RAS in spring and summer with red drum fish stocked at 14-18 kg/m3. The water quality analysis showed that the P² trials maintained a stable alkalinity and PH balance. The M+P and H+P systems required alkalinity addition of 100-200 CaCO3 mg/L per trial.

The seasonal effects of temperature and light affected several parameters including periphyton growth rate, ammonia concentration, pH, and DO concentration. The periphyton in the ABCs generated DO (at an average of +3.95±6.52 mg/(L*d)). The M+P combination removed TAN at a higher rate than other ABCs although it consumed a higher amount of energy and DO. The microbiome of periphyton showed the presence of denitrifiers, ammonia oxidizing microbes, and nitrite oxidizing bacteria in a diverse community of microbes. All the systems maintained NO2−, NO3−, and CO2 below toxic limits.

The resource recovery showed that the H+P and P² had a high relative recovery of nutrients compared with the M+P combination. The P² system recovered nutrients in periphyton which could be repurposed as fish feed. The lipid content was 4.55±2.24% of the periphyton total dry weight with detectable Ω-3 fatty acids. The microbiome contained valuable microalgae that developed by natural selection, such as Chlorella. The H+P system produced both periphyton for fish feed and edible sea purslane. Sea purslane growth rates (1.0431±0.3361 g/day/plant) were high. Fish mortalities in trials were low and the FCR was between 1.1-2.0 for all trials, although it generally increased as the fish aged or due to the 91 temperature increase. The overall results indicate that periphyton combines well in ABCs to help denitrify, stabilize the pH/alkalinity, photosynthesize, and produce a value-added product.

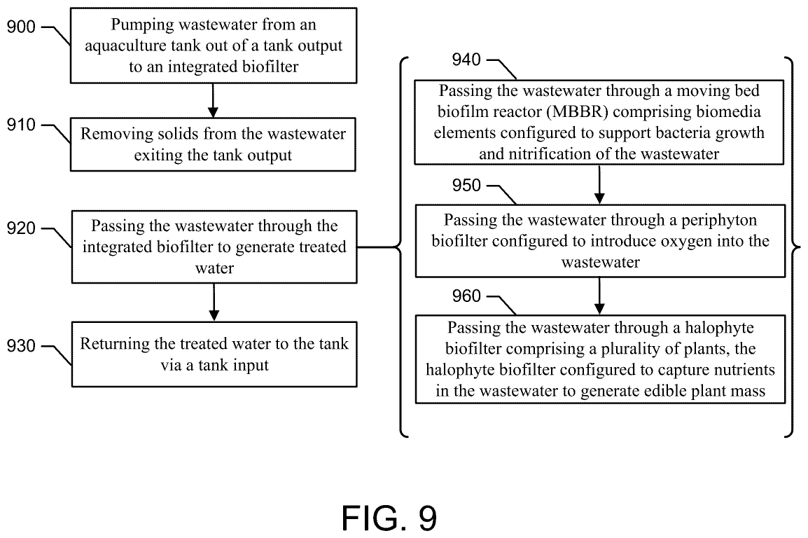

Now with reference to FIG. 9, according to some example embodiments, an example method for operating a re-circulating aquaculture system is provided. The example method may comprise, at 900, pumping wastewater from an aquaculture tank out of a tank output to an integrated biofilter. The example method may also comprise, at 910, removing solids from the wastewater exiting the tank output, and, at 920, passing the wastewater through the integrated biofilter to generate treated water. In this regard, passing the wastewater through the integrated biofilter may comprise, at 940, passing the wastewater through a moving bed biofilm reactor (MBBR) comprising biomedia elements configured to support bacteria growth and nitrification of the wastewater, at 950, passing the wastewater through a periphyton biofilter configured to introduce oxygen into the wastewater, and, at 960, passing the wastewater through a halophyte biofilter comprising a plurality of plants. In this regard, the halophyte biofilter may be configured to capture nutrients in the wastewater to generate edible plant mass. According to some example embodiments, the example method may also include, at 930, returning the treated water to the tank via a tank input.

According to some example embodiments, the periphyton biofilter of the example method may comprise pond scum, biofilm, microphytobenthos, aufwuchs, or the like. Additionally, according to some example embodiments, the example method may further comprise implementing an adenosine triphosphate (ATP) synthase binding cassette, performing carbon dioxide scrubbing, and reintroducing oxygen. Additionally or alternatively, the example method may further comprise dispensing the edible plant mass into the tank, in a controlled manner, as fish feed. Additionally or alternatively, the example method may further comprise passing the wastewater through a clarifier operably coupled between the tank output and the tank input. Additionally or alternatively, the periphyton biofilter of the example method may comprise a polyethylene net.

Many modifications and other embodiments of the example embodiments set forth herein will come to mind to one skilled in the art to which these inventions pertain having the benefit of the teachings presented in the foregoing descriptions and the associated drawings. Therefore, it is to be understood that the example embodiments are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits, or solutions described herein should not be thought of as being critical, required, or essential to all embodiments or to that which is claimed herein. Although specific terms are employed herein, they are used in a generic and descriptive sense only and not for purposes of limitation.

What is claimed is:

1. A land-based re-circulating aquaculture system comprising:
a tank having a tank input and a tank output;
a filter operably coupled between the tank output and the tank input;
a pump operably coupled between the tank output and the tank input and configured to pump wastewater from the tank output through the filter to the tank input; and
a solids removal unit operably coupled to the pump and configured to remove solids from the wastewater exiting the tank output;
wherein the filter comprises:
a moving bed biofilm reactor (MBBR) comprising:
biomedia elements configured to support bacteria growth and nitrification of the wastewater; and
an MBBR output configured to output biomass generated by the bacteria;
a periphyton biofilter configured to introduce oxygen into the wastewater; and
a halophyte biofilter configured to capture nutrients in the wastewater to generate edible plant mass.

2. The land-based aquaculture system of claim 1, wherein the periphyton biofilter comprises an algal and bacterial biofilm.

3. The land-based aquaculture system of claim 1, wherein the filter is configured to implement an adenosine triphosphate (ATP) synthase binding cassette, perform carbon dioxide scrubbing, and reintroduction of oxygen.

4. The land-based aquaculture system of claim 1 further comprising a fish feed sub-system, wherein the fish feed sub-system is configured to store and dispense the edible plant mass into the tank, in a controlled manner, as fish feed.

5. The land-based aquaculture system of claim 1 further comprising a clarifier operably coupled between the tank output and the tank input.

6. The land-based aquaculture system of claim 1, wherein the periphyton biofilter comprises a polyethylene net.

7. An integrated biofilter for a re-circulating aquaculture system, the biofilter comprising:
a moving bed biofilm reactor (MBBR) comprising:
biomedia elements configured to support bacteria growth and nitrification of the wastewater; and
an MBBR output configured to output biomass generated by the bacteria;
a periphyton biofilter configured to introduce oxygen into the wastewater; and
a halophyte biofilter comprising a plurality of plants, the halophyte biofilter configured to capture nutrients in the wastewater to generate edible plant mass.

8. The integrated biofilter of claim 7, wherein the periphyton biofilter comprises pond scum, biofilm, microphytobenthos, or aufwuchs.

9. The integrated biofilter of claim 7, wherein the biofilter is further configured to implement an adenosine triphosphate (ATP) synthase binding cassette, perform carbon dioxide scrubbing, and reintroduction of oxygen.

10. The integrated biofilter of claim 7 further comprising a clarifier.

11. The integrated biofilter of claim 7, wherein the periphyton biofilter comprises a polyethylene net.

12. A method for operating a re-circulating aquaculture system, the method comprising:
pumping wastewater from an aquaculture tank out of a tank output to an integrated biofilter;
removing solids from the wastewater exiting the tank output;
passing the wastewater through the integrated biofilter to generate treated water, wherein passing the wastewater through the integrated biofilter comprises:
passing the wastewater through a moving bed biofilm reactor (MBBR) comprising biomedia elements configured to support bacteria growth and nitrification of the wastewater;
passing the wastewater through a periphyton biofilter configured to introduce oxygen into the wastewater; and
passing the wastewater through a halophyte biofilter comprising a plurality of plants, the halophyte biofilter configured to capture nutrients in the wastewater to generate edible plant mass; and
returning the treated water to the tank via a tank input.

13. The method of claim 12, wherein the periphyton biofilter comprises pond scum, biofilm, microphytobenthos, or aufwuchs.

14. The method of claim 12 further comprising implementing an adenosine triphosphate (ATP) synthase binding cassette, performing carbon dioxide scrubbing, and reintroducing oxygen.

15. The method of claim 12 further comprising dispensing the edible plant mass into the tank, in a controlled manner, as fish feed.

16. The method of claim 12 further comprising passing the wastewater through a clarifier operably coupled between the tank output and the tank input.

17. The method of claim 12, wherein the periphyton biofilter comprises a polyethylene net.
